(19) United States
(12) Patent Application Publication
(10) Pub. No.: US 2026/0297432 A1
(43) Pub. Date: Oct. 1, 2026

(54) METHOD FOR PYROLYZING A PLASTIC

(71) Applicant: OMV DOWNSTREAM GMBH, Wien (AT)

(72) Inventors: Andreas LECHLEITNER, Wien (AT); Matthias MASTALIR, Wien (AT)

(21) Appl. No.: 19/475,873

(22) PCT Filed: Apr. 18, 2024
(86) PCT No.: PCT/EP2024/060472

§ 371 Date: Oct. 16, 2025

(30) Foreign Application Priority Data
Apr. 18, 2023 (EP) 23168533.0

(51) Int. Cl. C10G 1/10

(52) U.S. Cl. CPC C10G 1/10; C10G 2300/1003

(57) ABSTRACT

A method for pyrolyzing a plastic, in particular a waste plastic, includes the steps of (a) pyrolyzing the plastic in a first pyrolysis reactor to obtain a first pyrolysis product, (b) separating a pyrolysis residue from the first pyrolysis product in a first separating unit, (c) separating the pyrolysis residue into a low-solid fraction and a high-solid fraction in a second separating unit, and (d) pyrolyzing the high-solid fraction in a second pyrolysis reactor to obtain a second pyrolysis product. A device for pyrolyzing a plastic uses the method.

The invention relates to a method and a device for pyrolyzing of a plastic, in particular a waste plastic.

Methods for pyrolyzing a starting material, in particular a plastic, are known in the prior art. The focus here is on the separation of a gaseous fraction from a pyrolysis product, while the rest of the pyrolysis product, in particular a high-solid fraction, is typically used for energy purposes.

For example, EP 1 154 007 A1 discloses a method for the pyrolysis of a waste plastic. In this case, the waste plastic is pyrolyzed in a first pyrolysis reactor at a first temperature, a first pyrolysis product comprising a first gaseous fraction and a first pyrolysis residue being obtained. The first pyrolysis residue is then pyrolyzed in a second pyrolysis reactor at a second temperature higher than the first temperature, wherein a second pyrolysis product comprising a second gaseous fraction and a second pyrolysis residue is obtained. The second pyrolysis residue is subjected to a magnetic separation method to obtain inorganic fillers and scrap metals.

A further method for the pyrolysis of a waste plastic is described in WO 2016/116114 A1. The waste plastic is converted in a pyrolysis reactor into a pyrolysis product comprising a gaseous fraction and a solid pyrolysis residue. The pyrolysis residue is then separated in a separating unit, for example in a cyclone, into a low-solid fraction and a high-solid fraction. The low-solid fraction is returned to the pyrolysis reactor for renewed pyrolysis. The high-solid fraction is separated in a settling tank based on its density. A first portion of the lower density high-solid fraction is returned to the pyrolysis reactor together with the low-solid fraction, while a second portion of the higher density high-solid fraction can be used as a high-energy fuel.

Further methods for pyrolyzing starting materials are known from WO 2017/168163 A1, US 2022/340819 A1, US 2012/117860 A1 and EP 4 151 702 A1.

It is true that the pyrolysis product can be at least partially recycled with some of these methods. However, there is a need for a method with a reduced CO₂ footprint and a greater contribution to the circular economy and sustainability. It is an object of this invention to recycle a larger portion of the pyrolysis residue compared to the known methods.

The method according to the invention for pyrolyzing a plastic comprises the steps
(a) pyrolyzing the plastic in a first pyrolysis reactor to obtain a first pyrolysis product,
(b) separating a pyrolysis residue from the first pyrolysis product in a first separating unit,
(c) separating the pyrolysis residue into a low-solid fraction and a high-solid fraction in a second separating unit, and
(d) pyrolyzing the high-solid fraction in a second pyrolysis reactor to obtain a second pyrolysis product.

The invention is further directed to a device for pyrolyzing a plastic, in particular a waste plastic, with the method according to the invention, comprising
a first pyrolysis reactor for pyrolyzing the plastic,
a first separating unit for separating the pyrolysis residue from the first pyrolysis product,
a second separating unit for separating the pyrolysis residue into the low-solid fraction and the high-solid fraction, and
a second pyrolysis reactor for pyrolyzing the high-solid fraction.

By carrying out two pyrolysis steps in two different pyrolysis reactors and separating the pyrolysis residue into a low-solid fraction and a high-solid fraction between the two pyrolysis steps, this method and this device enable the first or second pyrolysis product to be processed particularly well and separated into individual components, as a result of which a high degree of recycling can be achieved. The method can therefore relieve the environment, as greenhouse gas emissions can be reduced and the amount of waste can be reduced. Overall, this can significantly reduce resource consumption and strengthen the circular economy, which can also bring economic benefits.

The plastic preferably comprises a polyolefin and/or a polystyrene (PS), wherein the polyolefin may comprise a polyethylene (PE) and/or a polypropylene (PP). The plastic preferably comprises the polyolefin and/or the polystyrene in an amount of at least 65% by weight, more preferably at least 70% by weight, in particular at least 90% by weight, based on the total weight of the plastic. As a result, a pyrolysis residue can be obtained which comprises a significant proportion of an aliphatic hydrocarbon (or a mixture of a plurality of aliphatic hydrocarbons).

The plastic preferably comprises at least 20% by weight of the polyolefin, more preferably at least 50% by weight, even more preferably at least 70% by weight, in particular at least 90% by weight, based on the total weight of the plastic. As the proportion of polyolefin increases, the amount of wax obtained by the method according to the invention can be increased, which can improve the cost-effectiveness of the method. The plastic may comprise a further polymer from the group consisting of thermoplastics, duromers and/or elastomers, in particular an acrylonitrile-butadiene-styrene copolymer (ABS), a polyvinyl chloride (PVC), a polyamide (PA) and/or a polyester.

Before step (a) of the method, the plastic can be plasticized, for example in a mixer, in particular in an extruder. The plastic is preferably heated to a temperature of at least 120 °C in order to plasticize it, more preferably to a temperature of 200 to 500 °C, even more preferably of 400 to 470 °C. Then the subsequent pyrolysis can be carried out more energy-efficiently and in a shorter time.

In the extruder, the plastic can also be degassed to produce a uniform mass without gas inclusions, so that a homogeneous pyrolysis product can be obtained by the subsequent pyrolysis.

Before step (a) of the method, a diluent for viscosity reduction may be added to the plastic, in particular the plasticized plastic. For this purpose, the device may have an introduction device that is configured to add a diluent for viscosity reduction to the plastic before the pyrolysis in the first pyrolysis reactor. The diluent is preferably added to the plastic in an amount of at least 5% by weight, more preferably at least 9% by weight, based on the total weight of the plastic. The ratio of plastic to diluent is preferably at least 1:4, preferably at least 1:9. By adding the diluent to the plastic, the mobility of polymer chains can be increased at a given temperature, so that heat input into the plastic can be improved during pyrolysis. Furthermore, due to the viscosity reduction, the risk of plastic overheating in wall areas of the pyrolysis reactor can be reduced, since it is usually heated by a heating device arranged near an outer wall of the pyrolysis reactor. The risk of coking of the plastic during pyrolysis can also be reduced by reducing the viscosity.

By adding the diluent to the plastic, its viscosity can preferably be reduced by at least 30%, more preferably by at least 50%, particularly preferably by at least 80%, based on the viscosity of the plastic without diluent under the same measurement conditions, in particular at a temperature in the range from 180 to 240 °C. This can improve the pumpability of the plastic, which can facilitate its processing.

When the diluent is added, the plastic preferably has a temperature of at least 120 °C, more preferably a temperature of 150 to 300 °C, in particular 200 to 300 °C. Alternatively or additionally, the diluent can be heated to a temperature of preferably at least 120 °C, more preferably at least 150 °C, in particular to a temperature of 200 to 300 °C, before being added to the plastic. By increasing the temperature of the plastic and/or the diluent, the diluent can be mixed into the plastic more quickly and efficiently. The subsequent pyrolysis can also be carried out more energy-efficiently and faster.

The diluent can be added to the plastic by means of a feed device. The feed device may have a metering device, such as a metering pump. For example, the plastic, in particular the plasticized plastic, can be fed to a mixer, e.g. a static mixer, and mixed there with the diluent. If the plastic is plasticized in an extruder, the diluent can be added directly in the extruder. For this purpose, the feed device can be arranged, for example, in the compression zone or mixing zone of the extruder.

The diluent may comprise a hydrocarbon selected from an alkane, a cycloalkane, and/or an aromatic. As a result of the pyrolysis, such a diluent can be converted into a gaseous and/or liquid product, which can be at least partially separated from the pyrolysis residue and reused. In particular, the diluent may comprise a fraction obtained from crude oil, preferably a heavy oil. The heavy oil can be an oil obtained from petroleum in a petroleum refinery, e.g. a residual oil from a pyrolysis system. The heavy oil preferably has a proportion of an aromatic hydrocarbon of at least 25% by weight, based on the total weight of the heavy oil.

Alternatively or additionally, the diluent may comprise a portion of the liquid fraction of the first pyrolysis product and/or a portion of the low-solid fraction. This may allow the reuse of the liquid fraction and the low-solid fraction. The diluent preferably consists of at least a portion of the liquid fraction of the first pyrolysis product and/or at least a portion of the low-solid fraction. Then a high degree of recycling can be achieved.

The diluent preferably has a boiling temperature (or a lower end of a boiling range) of at least 300 °C, in particular at least 350 °C. As a result, the diluent can be prevented from evaporating immediately after a mixture of plastic and diluent has been introduced into the pyrolysis reactor, but evaporation, cleavage and/or depolymerization of the diluent can only take place with the progressive residence time of the mixture in the pyrolysis reactor and the associated heating of the mixture. As a result, a homogeneous pyrolysis product can be obtained.

In step (a) of the method, the plastic is pyrolyzed in a first pyrolysis reactor. The first pyrolysis reactor may be a screw reactor, a fluidized bed reactor, a rotary tube reactor, or a coker, preferably a coker.

In step (a) of the method, the temperature in the first pyrolysis reactor is preferably in the range from 300 to 800 °C, more preferably from 350 to 700 °C. The pressure in the first pyrolysis reactor in step (a) is preferably in the range from 1 to 30 bar, more preferably from 5 to 30 bar, even more preferably 10 to 25 bar. Furthermore, pyrolysis is preferably carried out in step (a) for a period of 0.3 min, more preferably for a period of 1 to 10 min, in particular 1.5 to 5 min. As a result, a good balance between cost-effectiveness and method efficiency can be achieved.

The pyrolysis in step (a) may be thermal pyrolysis (i.e., thermal cracking, without addition of a catalyst) and/or catalytic pyrolysis (i.e., catalytic cracking). Thermal pyrolysis is preferred to avoid any contamination of the wax and/or solid due to catalyst components.

The pyrolysis in step (a) can be carried out largely in the absence of oxygen, in particular in an inert atmosphere, for example under nitrogen. Due to a lack of oxygen or exclusion of oxygen, complete combustion can be prevented and a polymer contained in the plastic can be cleaved or depolymerized.

The first pyrolysis product comprises a pyrolysis residue. Furthermore, the first pyrolysis product comprises a liquid fraction and/or a gaseous fraction. In step (b) of the method, the pyrolysis residue is separated from the first pyrolysis product in a first separating unit. The separation can take place by evaporation and/or centrifugal separation (i.e. centrifugation), preferably by centrifugal separation. Accordingly, the first separating unit may comprise an evaporator, a cyclone, and/or a hydrocyclone, in particular a hydrocyclone.

The temperature in the first separating unit in step (b) is preferably in the range from 300 to 700 °C, more preferably in the range from 330 to 420 °C. The pressure in the first separating unit in step (b) is preferably in the range from 1 to 15 bar, more preferably in the range from 2 to 8 bar. Efficient and good separation of the pyrolysis residue can be achieved with these method parameters.

The first separating unit preferably has a hydrocyclone, with which the gaseous fraction, the liquid fraction and the pyrolysis residue can be separated from one another in only one method step. Such a hydrocyclone is described in the application WO 2023/036751 A1. By introducing the first pyrolysis product via an inlet arranged in an upper region of a shell of the hydrocyclone, a vortex flow can be generated in the hydrocyclone, as a result of which the gaseous fraction can be separated from the first pyrolysis product and discharged via an outlet arranged in the upper region of the hydrocyclone (e.g. on its ceiling). The remaining portion of the first pyrolysis product can then be discharged in the direction of a bottom of the hydrocyclone due to gravity, wherein a tangential velocity of a vortex flow that forms can continuously increase. As a result, at least a portion of the pyrolysis residue can be discharged via an outlet arranged in the bottom of the hydrocyclone, while at least a portion of a liquid fraction of the first pyrolysis product can pass into an inner container arranged in the hydrocyclone and can be discharged from there via an outlet. This portion of the liquid fraction can then be used as a diluent for viscosity reduction of the plastic prior to step (a) of the method. The pyrolysis residue discharged via the outlet disposed in the bottom of the hydrocyclone can then be used in step (c) of the method. The hydrocyclone is preferably operated at a temperature in the range from 300 to 450 °C, more preferably from 320 to 420 °C, particularly preferably from 360 to 400 °C.

The pyrolysis residue separated in step (b) of the method preferably has a boiling temperature (or a lower end of a boiling range) of at least 250 °C, more preferably at least 300 °C, even more preferably at least 330 °C, particularly preferably at least 350 °C. The boiling temperature (or the boiling range) of the pyrolysis residue can be determined by means of the standard ASTM D7500-15:2019 (preferably if the pyrolysis residue has a boiling temperature or a boiling range of 100 to 850 °C, in particular 100 to 735 °C) or by means of the standard ASTM D2887-22:2022 (preferably if the pyrolysis residue has a boiling temperature or a boiling range of 55 to 538 °C).

The pyrolysis residue separated in step (b) of the method preferably comprises a carbon fraction having at least 14 carbon atoms per molecule, more preferably at least 16 carbon atoms per molecule, particularly preferably at least 18 carbon atoms per molecule. The pyrolysis residue can then be separated well in the following step (c) of the method.

In step (c) of the method, the pyrolysis residue is separated in a second separating unit into a low-solid fraction and a high-solid fraction. The low-solid fraction preferably has a liquid proportion of more than 70% by weight, preferably more than 80% by weight, more preferably more than 85% by weight, more preferably more than 90% by weight, more preferably more than 95% by weight, more preferably more than 98% by weight, more preferably more than 99% by weight. The low-solid fraction preferably has a liquid proportion in the range from 80 to 100% by weight, more preferably 90 to 99.9% by weight, based on the total weight of the low-solid fraction. The low-solid fraction preferably has a density at 20 °C and 101325 Pa in the range of 0.600 to 1.100 g/cm³, more preferably 0.750 to 0.990 g/cm³.

The high-solid fraction preferably has a liquid proportion of less than 95% by weight, preferably less than 90% by weight, more preferably less than 85% by weight, more preferably less than 80% by weight, more preferably less than 75% by weight, more preferably less than 70% by weight. The high-solid fraction preferably has a liquid proportion in the range from 50 to 95% by weight, more preferably 70 to 90% by weight, based on the total weight of the high-solid fraction. The high-solid fraction preferably has a density at 20 °C and 101325 Pa in the range of 0.650 to 1.300 g/cm³, more preferably 0.800 to 1.150 g/cm³. Preferably, the high-solid fraction has a lower liquid proportion than the low-solid fraction. It is also preferred if the high-solid fraction has a higher density at 20 °C and 101325 Pa than the low-solid fraction.

The separation in the second separating unit may comprise gravimetric separation, filtration, and/or centrifugal separation, preferably centrifugal separation. Gravimetric separation may include sedimentation and/or decantation. Accordingly, the second separating unit may comprise a device for gravimetric separation, a filter, a centrifuge, and/or a hydrocyclone, preferably a hydrocyclone. The device for gravimetric separation may comprise a sedimentation system and/or a decanter. If the second separating unit comprises a hydrocyclone, it may be constructed and operated in the same or similar manner as the hydrocyclone of the first separating unit, as described above.

Preferably, the separation in the second separating unit in step (c) comprises centrifugal separation in combination with filtration or gravimetric separation. The centrifugal separation can take place before the filtration or before the gravimetric separation. Accordingly, the second separating unit may include the hydrocyclone in combination with the filter or device for gravimetric separation. The hydrocyclone may be upstream of the filter or device for gravimetric separation. In this way, a sharp separation into the low-solid fraction and the high-solid fraction can take place.

The temperature in the second separating unit in step (c) is preferably in the range of 100 to 700 °C, more preferably 100 to 350 °C, even more preferably 100 to 200 °C. During gravimetric separation or filtration, the temperature is preferably in the range of 180 to 700 °C. During centrifugation, the temperature is preferably 200 °C or below, more preferably in the range from 100 to 180 °C. During centrifugal separation, the temperature is preferably in the range from 200 to 700 °C. If the temperature is selected as indicated depending on the method, the separation into a low-solid fraction and a high-solid fraction can take place efficiently.

In step (d) of the method, the high-solid fraction is pyrolyzed in a second pyrolysis reactor to obtain a second pyrolysis product. The second pyrolysis reactor may be a screw reactor, a fluidized bed reactor, a rotary tube reactor, or a coker, preferably a coker. The temperature in the second pyrolysis reactor is preferably in the range from 400 to 800 °C, more preferably in the range from 500 to 700 °C. This allows the high-solid fraction to be pyrolyzed efficiently.

The temperature during pyrolysis in the second pyrolysis reactor in step (d) may be higher than the temperature during pyrolysis in the first pyrolysis reactor in step (a). The temperature in the second pyrolysis reactor is preferably at least 50 °C higher than the temperature in the first pyrolysis reactor, more preferably at least 80 °C, even more preferably at least 100 °C, even more preferably at least 150 °C, in particular at least 200 °C.

The pressure in the second pyrolysis reactor is preferably in the range from 1 to 20 bar, more preferably in the range from 2 to 12 bar, in particular 2 to 8 bar. In the second pyrolysis reactor, pyrolysis is preferably carried out for a period of from 1 to 90 minutes, in particular from 1.5 to 5 minutes. As a result, a good balance between cost-effectiveness and method efficiency can be achieved.

A ratio of the volumetric capacity of the first pyrolysis reactor and the second pyrolysis reactor is a maximum of 10:3, more preferably a maximum of 10:2, preferably in the range from 10:0.2 to 10:2, in particular from 10:1 to 10:2. The volumetric capacity is understood to be the maximum possible filling level of the respective pyrolysis reactor.

The second pyrolysis product may comprise a solid, a gas, and/or a liquid.

The amount of gas is preferably at least 10% by weight, more preferably at least 20% by weight, even more preferably at least 40% by weight, based on the total weight of the second pyrolysis product. The gas preferably comprises a proportion of a carbon fraction of at least 5% by weight, more preferably at least 15% by weight, even more preferably at least 20% by weight, in particular at least 40% by weight, based on the total weight of the gas. The carbon fraction of the gas preferably comprises methane, ethane, ethene, propane, propene, butane, butene, butadiene, or a mixture of these components. These components of the gas can be separated from one another, for example by fractional distillation, in order to supply them for further use, for example other systems of a refinery.

The liquid preferably comprises an oil, wherein the oil may comprise a light oil and a heavy oil. The light oil may comprise a carbon fraction of 3 to 14 carbon atoms per molecule, and the heavy oil may comprise a carbon fraction of 11 to 50 carbon atoms per molecule. Separation of individual components of the oil from one another, in particular individual components of the carbon fraction from one another, can take place, for example, by fractional distillation, which allows subsequent further use, for example as a fuel. The separation of the gas and the liquid from one another and the separation of the gas and/or the liquid into individual components can be carried out in the same distillation apparatus.

The amount of the solid is preferably at most 70% by weight, more preferably at most 55% by weight, even more preferably at most 30% by weight, based on the total weight of the second pyrolysis product. The solid may comprise an inorganic salt, a ceramic raw material, an asphaltene, a tar, and/or a coke. In particular, the solid may comprise talc, an iron oxide (e.g., ferric oxide), aluminum oxide, titanium dioxide, magnesium oxide, and/or calcium carbonate. If the provided pyrolysis residue is obtained by pyrolyzing a plastic, the solid may comprise an additive contained in the plastic. For example, the additive may comprise a filler, a color pigment, and/or an additive. A specialist knows which additives are used depending on the respective plastic and field of application.

The method may comprise a further step (e): separating at least a portion of the solid from the second pyrolysis product. For this purpose, the device may have a solid-separation device.

The separation of the solid from the second pyrolysis product may comprise gravimetric separation, filtration, and/or centrifugal separation, preferably filtration. Gravimetric separation may include sedimentation and/or decantation. If the separation comprises a filtration, this can be carried out with a filter medium, which can comprise an activated carbon or a bleaching earth. As a result, any polar components (e.g. a tar or a polyphenol) dissolved in the solvent together with the wax can be separated and adsorbed by the filter medium. During filtration, particles with an average particle size (D50) of less than 100 μm, in particular less than 50 μm, can also be easily removed (determined by means of laser diffractometry).

The separation of the solid from the second pyrolysis product may also take place directly in the second pyrolysis reactor. For these purposes, the second pyrolysis reactor is preferably a screw reactor. The solid can be discharged directly from the extruder by means of a discharge device.

After it has been separated from the second pyrolysis product, i.e. after step (e) of the method, the solid can be dried, for example in an oven. As a result, the solid can be made free-flowing and thus easier to process. The solid is preferably dried at a temperature in the range from 50 to 250 °C, more preferably from 100 to 200 °C, even more preferably from 130 to 160 °C. The drying time is preferably up to 120 min, in particular from 5 to 60 min. One or more components can be separated from the solid, in particular from the dried solid, and then re-used, for example as an additive for a plastic.

The invention relates in particular to the following embodiments:
1. A method for pyrolyzing a plastic, in particular a waste plastic, comprising the steps
   (a) pyrolyzing the plastic in a first pyrolysis reactor to obtain a first pyrolysis product,
   (b) separating a pyrolysis residue from the first pyrolysis product in a first separating unit,
   (c) separating the pyrolysis residue into a low-solid fraction and a high-solid fraction in a second separating unit, and
   (d) pyrolyzing the high-solid fraction in a second pyrolysis reactor to obtain a second pyrolysis product.
2. The method according to embodiment 1, wherein the plastic comprises a polyolefin and/or a polystyrene (PS), wherein the polyolefin preferably comprises a polyethylene (PE) and/or a polypropylene (PP).
3. The method according to embodiment 2, wherein the plastic comprises the polyolefin and/or the polystyrene in an amount of at least 65% by weight, more preferably at least 70% by weight, in particular at least 90% by weight, based on the total weight of the plastic.
4. The method according to embodiment 2 or 3, wherein the plastic comprises at least 20% by weight of a polyolefin, preferably at least 50% by weight, more preferably at least 70% by weight, in particular at least 90% by weight, based on the total weight of the plastic.
5. The method according to any one of the preceding embodiments, wherein the plastic is heated to a temperature of at least 120 °C, preferably to a temperature of 200 to 500 °C, more preferably of 400 to 470 °C, before step (a).
6. The method according to any one of the preceding embodiments, wherein a viscosity reducing diluent is added to the plastic prior to step (a).
7. The method according to embodiment 6, wherein the diluent is added to the plastic in an amount of at least 5% by weight, more preferably at least 9% by weight, based on the total weight of the plastic.
8. The method according to embodiment 6 or 7, wherein the ratio of plastic to diluent is at least 1:4, preferably at least 1:9.
9. The method according to any one of embodiments 6 to 8, wherein the diluent comprises a hydrocarbon selected from an alkane, a cycloalkane, and/or an aromatic.
10. The method according to any one of embodiments 6 to 9, wherein the diluent comprises a fraction obtained from crude oil, preferably a heavy oil, in particular a heavy oil having an aromatic hydrocarbon content of at least 25% by weight, based on the total weight of the heavy oil.
11. The method according to any one of embodiments 6 to 10, wherein the diluent comprises a portion of the liquid fraction of the first pyrolysis product and/or a portion of the low-solid fraction.
12. The method according to any one of embodiments 6 to 11, wherein the diluent has a boiling temperature of at least 300 °C, preferably at least 350 °C.
13. The method according to any one of embodiments 6 to 12, wherein the diluent and/or the plastic is/are heated to a temperature of at least 120 °C, preferably at least 150 °C, before the diluent is added to the plastic, preferably to a temperature in the range of 150 to 300 °C, more preferably to 200 to 300 °C.
14. The method according to any one of the preceding embodiments, wherein the temperature in the first pyrolysis reactor in step (a) is in the range from 300 to 800 °C, preferably from 350 to 700 °C.
15. The method according to any one of the preceding embodiments, wherein the pressure in the first pyrolysis reactor in step (a) is in the range from 1 to 30 bar, preferably from 5 to 30 bar, more preferably from 10 to 25 bar.
16. The method according to any one of the preceding embodiments, wherein pyrolysis is carried out in step (a) for a period of at least 0.3 min, preferably for a period of from 1 to 10 min, in particular from 1.5 to 5 min.
17. The method according to any one of the preceding embodiments, wherein the separating in the first separating unit in step (b) comprises evaporation and/or centrifugal separation, preferably centrifugal separation.
18. The method according to any one of the preceding embodiments, wherein the temperature in the first separating unit in step (b) is in the range from 300 to 700 °C, preferably from 330 to 420 °C.
19. The method according to any one of the preceding embodiments, wherein the pressure in the first separating unit in step (b) is in the range of 1 to 15 bar, preferably 2 to 8 bar.
20. The method according to any one of the preceding embodiments, wherein the pyrolysis residue separated in step (b) has a boiling temperature of at least 250 °C, preferably at least 300 °C, more preferably at least 330 °C, most preferably at least 350 °C.
21. The method according to any one of the preceding embodiments, wherein the pyrolysis residue separated in step (b) comprises a carbon fraction having at least 14 carbon atoms per molecule, preferably at least 16 carbon atoms per molecule, more preferably at least 18 carbon atoms per molecule.
22. The method according to any one of the preceding embodiments, wherein the low-solid fraction has a liquid proportion of more than 70% by weight, preferably more than 80% by weight, more preferably more than 85% by weight, more preferably more than 90% by weight, more preferably more than 95% by weight, more preferably more than 98% by weight, more preferably more than 99% by weight.
23. The method according to any one of the preceding embodiments, wherein the high-solid fraction has a liquid proportion of less than 95% by weight, preferably less than 90% by weight, more preferably less than 85% by weight, more preferably less than 80% by weight, more preferably less than 75% by weight, more preferably less than 70% by weight.
24. The method according to any one of the preceding embodiments, wherein the low-solid fraction has a liquid proportion in the range from 80 to 100% by weight, preferably from 90 to 99.9% by weight, based on the total weight of the low-solid fraction; and/or wherein the high-solid fraction has a liquid proportion in the range from 50 to 95% by weight, preferably from 70 to 90% by weight, based on the total weight of the high-solid fraction.
25. The method according to any one of the preceding embodiments, wherein the low-solid fraction has a density at 20 °C and 101325 Pa in the range of 0.600 to 1.100 g/cm³, preferably from 0.750 to 0.990 g/cm³, based on the total weight of the low-solid fraction; and/or wherein the high-solid fraction has a density at 20 °C and 101325 Pa in the range of 0.650 to 1.300 g/cm³, preferably from 0.800 to 1.150 g/cm³, based on the total weight of the high-solid fraction.
26. The method according to any one of the preceding embodiments, wherein the temperature in the second separating unit in step (c) is in the range from 100 to 700 °C, preferably from 100 to 350 °C, more preferably from 100 to 200 °C.
27. The method according to any one of the preceding embodiments, wherein the separating in the second separating unit in step (c) comprises gravimetric separation, filtration, and/or centrifugal separation, preferably centrifugal separation.
28. The method according to embodiment 27, wherein the separating in the second separating unit in step (c) comprises centrifugal separation in combination with filtration or gravimetric separation.
29. The method according to embodiment 27, wherein the centrifugal separation occurs prior to filtration or prior to gravimetric separation.
30. The method according to any one of embodiments 27 to 29, wherein the temperature during the gravimetric separation or filtration is in the range of 180 to 700 °C; wherein the temperature during the centrifugation is 200 °C or below, more preferably in the range of 100 to 180 °C; and/or wherein the temperature during the centrifugal separation is in the range of 200 to 700 °C.
31. The method according to any one of the preceding embodiments, wherein the temperature in the second pyrolysis reactor in step (d) is in the range of 400 to 800 °C, preferably in the range of 500 to 700 °C.
32. The method according to any one of the preceding embodiments, wherein the temperature during pyrolysis in the second pyrolysis reactor in step (d) is higher than the temperature during pyrolysis in the first pyrolysis reactor in step (a).
33. The method according to embodiment 32, wherein the temperature in the second pyrolysis reactor is at least 50 °C higher than the temperature in the first pyrolysis reactor, preferably at least 80 °C, more preferably at least 100 °C, even more preferably at least 150 °C, in particular at least 200 °C.
34. The method according to any one of the preceding embodiments, wherein the pressure in the second pyrolysis reactor in step (d) is in the range from 1 to 20 bar, preferably from 2 to 12 bar, more preferably from 2 to 8 bar.
35. The method according to any one of the preceding embodiments, wherein pyrolysis is carried out in step (d) for a period of 1 to 90 minutes, preferably 1.5 to 5 minutes.
36. The method according to any one of the preceding embodiments, wherein a ratio of the volumetric capacity of the first pyrolysis reactor and the second pyrolysis reactor is at most 10:3, preferably in the range from 10:0.2 to 10:2, more preferably from 10:1 to 10:2.
37. The method according to any one of the preceding embodiments, wherein the second pyrolysis product comprises a solid, a gas, and/or a liquid.
38. The method according to embodiment 37, wherein the amount of the gas is at least 10% by weight, preferably at least 20% by weight, more preferably at least 40% by weight, based on the total weight of the second pyrolysis product.
39. The method according to embodiment 37 or 38, wherein the gas comprises a proportion of a carbon fraction of at least 5% by weight, preferably at least 15% by weight, more preferably at least 20% by weight, in particular at least 40% by weight, based on the total weight of the gas.
40. The method according to embodiment 39, wherein the carbon fraction comprises methane, ethane, ethene, propane, propene, butane, butene, butadiene, or a mixture of these components.
41. The method according to any one of embodiments 37 to 40, wherein the liquid comprises an oil, preferably wherein the oil comprises a light oil and a heavy oil.
42. The method according to embodiment 41, wherein the light oil preferably comprises a carbon fraction of 3 to 14 carbon atoms per molecule, and/or wherein the heavy oil preferably comprises a carbon fraction of 11 to 50 carbon atoms per molecule.
43. The method according to any one of embodiments 37 to 42, wherein the amount of the solid is at most 70% by weight, preferably at most 55% by weight, more preferably at most 30% by weight, based on the total weight of the second pyrolysis product.
44. The method according to any one of embodiments 37 to 43, wherein the solid comprises an inorganic salt, a ceramic raw material, an asphaltene, a tar, and/or a coke.
45. The method according to any one of embodiments 37 to 44, further comprising step (e): separating at least a portion of the solid from the second pyrolysis product.
46. The method according to embodiment 45, wherein the separating in step (e) comprises gravimetric separation, filtration, and/or centrifugal separation, preferably filtration.
47. The method according to embodiment 46, wherein the filtration comprises separating with a filter medium containing an activated carbon or a bleaching earth.
48. The method according to any one of embodiments 45 to 47, wherein the solid is dried after step (e), preferably at a temperature in the range from 50 to 250 °C, more preferably from 100 to 200 °C, in particular from 130 to 160 °C; and/or for a period of up to 120 min, preferably from 5 to 60 min.
49. The method according to any one of embodiments 37 to 48, wherein the gas and/or liquid are separated from each other by fractional distillation.
50. The method according to embodiment 49, wherein the gas and/or the liquid are separated into individual components by means of the fractional distillation.
51. A device for the pyrolysis of a plastic, in particular a waste plastic, with a method according to one of embodiments 1 to 50, comprising
   a first pyrolysis reactor for pyrolyzing the plastic,
   a first separating unit for separating the pyrolysis residue from the first pyrolysis product,
   a second separating unit for separating the pyrolysis residue into the low-solid fraction and the high-solid fraction, and
   a second pyrolysis reactor for pyrolyzing the high-solid fraction.
52. The device according to embodiment 50, further comprising a feed device for adding a diluent to the plastic prior to pyrolysis in the first pyrolysis reactor.
53. The device according to embodiment 50 or 52, wherein the first pyrolysis reactor and/or the second pyrolysis reactor is/are a screw reactor, a fluidized bed reactor, a rotary tube reactor, or a coker, preferably a coker.
54. The device according to any one of embodiments 51 to 53, wherein the first separating unit comprises an evaporator, a cyclone, and/or a hydrocyclone, in particular a hydrocyclone.
55. The device according to any one of embodiments 51 to 54, wherein the second separating unit comprises a device for gravimetric separation, a filter, a centrifuge, and/or a hydrocyclone, preferably a hydrocyclone.
56. The device according to embodiment 55, wherein the second separating unit comprises the hydrocyclone in combination with the filter or the device for gravimetric separation, wherein the hydrocyclone is preferably upstream of the filter or the device for gravimetric separation.
57. The device according to any one of embodiments 51 to 56, further comprising a solid-separation device for separating at least a portion of a solid from the second pyrolysis product.
58. The device according to any one of embodiments 51 to 57, further comprising a distillation apparatus for separating a gas and/or a liquid from the second pyrolysis product.

The invention is explained in more detail below with reference to descriptions of figures of some embodiments, to which the invention is not limited, however.

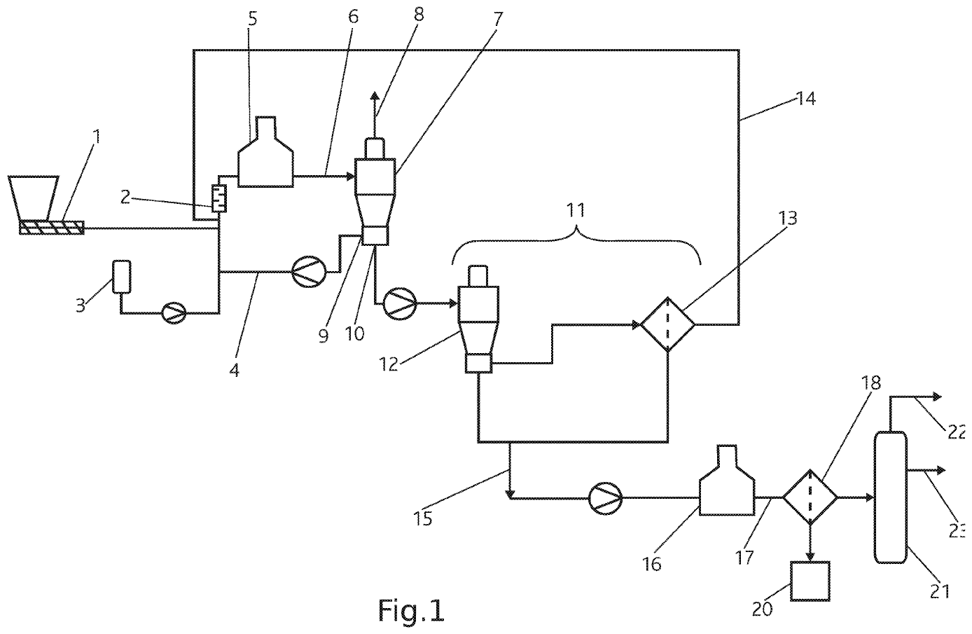

FIG. 1 shows a flow chart of a method for the pyrolysis of a plastic.

As can be seen from FIG. 1, a plastic comprising at least 50% by weight of a polyolefin is fed to an extruder 1, in which the plastic is plasticized and degassed. The plasticized plastic has a temperature of at least 120 °C and is then added to a static mixer 2. In the static mixer 2, a diluent 3 can be added to the plasticized plastic in order to reduce its viscosity. Alternatively or in addition to the diluent 3, a portion of a liquid fraction 4 separated from the first pyrolysis product 6 may be mixed with the plasticized plastic in order to reduce its viscosity. The obtained mixture is then fed to a first pyrolysis reactor 5, in which the plastic is pyrolyzed at a temperature of 350 to 700 °C. As a result, a first pyrolysis product 6 comprising a gaseous fraction, a liquid fraction and a pyrolysis residue is obtained. The first pyrolysis product 6 is fed to a first separating unit 7, which comprises a hydrocyclone and is connected downstream of the first pyrolysis reactor 5. First, the gaseous fraction is at least partially separated in the hydrocyclone. The separated portion of the gaseous fraction 8 can then be further separated into a light oil (e.g. with a boiling range of 35 to 225 °C) and a heavy oil (e.g. with a boiling range of 225 to 410 °C) (not shown). Furthermore, the liquid fraction is at least partially separated in the hydrocyclone. The separated portion of the liquid fraction 4 can be discharged via an outlet 9 of the hydrocyclone and reused in the method for viscosity reduction of the plastic, as described above. At least a portion of the pyrolysis residue, which at least partially comprises the pyrolysis residue, is discharged via an outlet 10 arranged in the bottom of the hydrocyclone.

As can further be seen in FIG. 1, the pyrolysis residue discharged via the outlet 10 is fed to a second separating unit 11, which has a hydrocyclone 12 and a filter 13, where it is separated into a low-solid fraction 14 and a high-solid fraction 15. The low-solid fraction has a liquid proportion in the range of 80 to 100% by weight, based on the total weight of the low-solid fraction; and/or wherein the high-solid fraction has a liquid proportion in the range of 50 to 95% by weight, based on the total weight of the high-solid fraction. The low-solid fraction 14 may be reused in the method by adding at least a portion of the low-solid fraction 14 to the plasticized plastic in the mixer 2 for viscosity reduction. The high-solid fraction 15 is then pyrolyzed in a second pyrolysis reactor 16 at a temperature in the range from 500 to 700 °C, the temperature in the second pyrolysis reactor 16 being at least 80 °C higher than in the first pyrolysis reactor 5 in order to obtain a second pyrolysis product 17. At least a portion of the solid is separated from the second pyrolysis product 17 by means of a solid-separation device 18 having a filter. In this case, a filter medium of the filter comprises an activated carbon. The separated portion of the solid 19 is dried in an oven 20 at a temperature of 100 to 200 °C. Subsequently, individual components can be separated from the solid and reused (not shown). The remaining portion of the second pyrolysis product is separated into a gas 22 and a liquid 23 in a distillation apparatus 21 by means of a fractional distillation, or can also be separated into one or more components of a gas and/or one or more components of a liquid.

1. A method for pyrolyzing a plastic, in particular a waste plastic, comprising the steps
(a) pyrolyzing the plastic in a first pyrolysis reactor to obtain a first pyrolysis product,
(b) separating a pyrolysis residue from the first pyrolysis product in a first separating unit,
(c) separating the pyrolysis residue into a low-solid fraction and a high-solid fraction in a second separating unit, and
(d) pyrolyzing the high-solid fraction in a second pyrolysis reactor to obtain a second pyrolysis product.

2. The method according to claim 1, wherein the pyrolysis residue separated in step (b) has a boiling temperature of at least 250 °C.

3. The method according to claim 1, wherein the low-solid fraction has a liquid proportion in the range of 80 to 100% by weight, based on the total weight of the low-solid fraction; and/or wherein the high-solid fraction has a liquid proportion in the range of 50 to 95% by weight, based on the total weight of the high-solid fraction.

4. The method according to claim 1, wherein the separating in the second separating unit in step (c) comprises centrifugal separation.

5. The method according to claim 4, wherein the separating in the second separating unit in step (c) comprises centrifugal separation in combination with filtration or gravimetric separation.

6. The method according to claim 1, wherein a ratio of the volumetric capacity of the first pyrolysis reactor and the second pyrolysis reactor is at most 10:3.

7. The method according to claim 1, wherein the second pyrolysis product comprises a solid, a gas, and/or a liquid.

8. The method according to claim 7, wherein the gas comprises a proportion of a carbon fraction of at least 20% by weight, based on the total weight of the gas.

9. The method according to claim 7, wherein the amount of the solid is at most 70% by weight based on the total weight of the second pyrolysis product.

10. The method according to claim 1, further comprising step (e): separating at least a portion of the solid from the second pyrolysis product.

11. The method according to claim 10, wherein the separating in step (e) comprises filtration, preferably with a filter medium containing an activated carbon or a bleaching earth.

12. A device for pyrolyzing a plastic, in particular a waste plastic, with the method according to claim 1, comprising
a first pyrolysis reactor for pyrolyzing the plastic,
a first separating unit for separating the pyrolysis residue from the first pyrolysis product,
a second separating unit for separating the pyrolysis residue into the low-solid fraction and the high-solid fraction, and
a second pyrolysis reactor for pyrolyzing the high-solid fraction.

13. The device according to claim 12, wherein the second separating unit comprises a hydrocyclone.

14. The device according to claim 13, wherein the second separating unit comprises the hydrocyclone in combination with a filter or a device for gravimetric separation.

15. The device according to claim 12, further comprising a solid-separation device for separating at least a portion of a solid from the second pyrolysis product.
